(19) United States
(12) Patent Application Publication
(10) Pub. No.: US 2016/0265951 A1
(43) Pub. Date: Sep. 15, 2016

(54) PERFORMANCE INFORMATION CALCULATION METHOD, AND POSITIONING SATELLITE SIGNAL RECEIVER

(71) Applicant: Seiko Epson Corporation, Tokyo (JP)

(72) Inventors: Tatsuhiko SUGIYAMA, Shiojiri (JP); Naoki GOBARA, Shiojiri (JP); Tomoya KAWAMOTO, Shiojiri (JP)

(21) Appl. No.: 15/064,870

(22) Filed: Mar. 9, 2016

(30) Foreign Application Priority Data
Mar. 13, 2015 (JP) 2015-050849

(51) Int. Cl. G01D 18/00

(52) U.S. Cl. CPC G01D 18/00

(57) ABSTRACT

A performance information calculation method executed by an apparatus carried by a user who makes motion accompanied by cyclic body motion, and the method includes detecting motion cycle of the user, setting a reception action suspended period, during which a positioning satellite signal is not received, in each predetermined calculation cycle on the basis of the motion cycle, and calculating performance information in each of the calculation cycles on the basis of the positioning satellite signal received in a period other than the reception action suspended period.

### CROSS-REFERENCE

This application claims priority to Japanese Patent Application No. 2015-050849, filed Mar. 13, 2015, the entirety of which is hereby incorporated by reference.

### BACKGROUND

1. Technical Field

The present disclosure relates to a performance information calculation method and the like for receiving a positioning satellite signal to calculate performance information.

2. Related Art

A portable electronic apparatus that incorporates a positioning satellite signal receiver, a representative example of which is a GPS (global positioning system) receiver, has become commonplace. A positioning satellite signal receiver receives a positioning satellite signal to measure and output the position, the velocity, and other types of information on the receiver and is required to reduce power consumption in order to allow long-term measurement. For example, JP-A-2009-175123 discloses a technology for intermittently receiving a positioning satellite signal to reduce power consumption.

As an example of the portable electronic apparatus that incorporates a positioning satellite signal receiver, what is called a running watch used in running and walking activities has been known. A running watch calculates not only the position and the velocity of a wearer in running and walking activities but also information including a cumulative travel distance, running pitch, and other parameters (hereinafter collectively referred to as “performance information”). It has been, however, found that since a running watch is generally attached to a user's arm or wrist for use, the method of the related art for intermittently performing the reception action can cause a performance information measurement error considered to result from the user's arm swinging action in running and walking activities.

### SUMMARY

An advantage of some aspects of the present disclosure is to reduce not only the performance information measurement error but also power consumption at the same time even when a portable electronic apparatus is attached to a user's arm or wrist.

A first aspect of the present disclosure is directed to a performance information calculation method executed by an apparatus carried by a user who makes motion accompanied by cyclic body motion, the method including detecting the user's motion cycle, setting a reception action suspended period, for which a positioning satellite signal is not received, out of each predetermined calculation cycle on the basis of the motion cycle, and calculating performance information in each of the calculation cycles on the basis of the positioning satellite signal received in a period other than the reception action suspended period.

As another aspect, the present disclosure may be configured as a positioning satellite signal receiver carried by a user who makes motion accompanied by cyclic body motion, the receiver including a detector that detects the user's motion cycle, a setter that sets a reception action suspended period, for which a positioning satellite signal is not received, out of each predetermined calculation cycle on the basis of the motion cycle, and a calculator that calculates performance information in each of the calculation cycles on the basis of the positioning satellite signal received in a period other than the reception action suspended period.

As still another aspect, the present disclosure may be configured as a program to cause a computer carried by a user who makes motion accompanied by cyclic body motion to detect the user's motion cycle, set a reception action suspended period, for which a positioning satellite signal is not received, out of each predetermined calculation cycle on the basis of the motion cycle, and calculate performance information in each of the calculation cycles on the basis of the positioning satellite signal received in a period other than the reception action suspended period.

A relative velocity difference occurs between a receiver carried by a user and a positioning satellite, and the user's motion accompanied by cyclic body motion causes the relative velocity difference to vary. The variation causes a positioning satellite signal reception frequency to vary. In the first aspect and other aspects, however, a reception action suspended period for which no positioning satellite signal is received can be set out of a performance information calculation cycle on the basis of the user's motion cycle. For example, a period for which a positioning satellite signal is received and a period for which no positioning satellite signal is received can be so set that the variation in the reception frequency (Doppler frequency) during a calculation cycle is eliminated. As a result, an error in performance information measurement based on a received positioning satellite signal can be reduced. Further, setting the reception action suspended period, for which no positioning satellite signal is received, in each calculation cycle allows reduction in power consumption. Therefore, even when the receiver is attached to the user's body, the power consumption can be reduced with an error in performance information measurement reduced.

As a more specific example, for example, as a second aspect, the performance information calculation method according to the first aspect may be configured such that the setting includes setting a remainder of the calculation cycle excluding N times the motion cycle (N is a natural number) to be the reception action suspended period.

According to the second aspect, the remainder of the calculation cycle excluding N times the motion cycle is set as the reception action suspended period. That is, in each performance information calculation period, positioning satellite signals corresponding to N times the motion cycle are received, but no positioning satellite signal is received in the remainder of the calculation cycle excluding N times the motion cycle. Since information in the received positioning satellite signals is information exactly corresponding to the N times motion cycle, using the average of pieces of information in the received positioning satellite signals allows calculation of performance information with the measurement error reduced. The accuracy of performance information measurement can therefore be ensured with the power consumption reduced.

As a third aspect, the performance information calculation method according to the second aspect may be configured such that the setting includes setting the reception action suspended period by using N=1.

According to the third aspect, receiving positioning satellite signals corresponding to one motion cycle to calculate performance information allows further reduction in power consumption, as compared with a case where positioning satellite signals corresponding to a plurality of motion cycles are received, with roughly the same degree of accuracy of performance information calculation ensured.

As a fourth aspect, the performance information calculation method according to any of the first to third aspects may be configured such that the method further includes intermittently performing reception of the positioning satellite signal in a period of the calculation cycle excluding the reception action suspended period.

According to the fourth aspect, reception of a positioning satellite signal is intermittently performed in the period of the performance information calculation cycle excluding the reception action suspended period. The power consumption can therefore be further reduced.

As a fifth aspect, the performance information calculation method according to any of the first to fourth aspects may be configured such that the calculating the performance information includes averaging pieces of measurement information in the positioning satellite signals received during the calculation cycle and calculating the performance information by using the averaged measurement information.

According to the fifth aspect, pieces of measurement information in positioning satellite signals received in the calculation cycle are averaged to calculate performance information. In a receiver that receives a positioning satellite signal and is carried by a user who makes motion accompanied by cyclic body motion, the positioning satellite signal reception frequency cyclically changes in accordance with the user's motion cycle. Therefore, setting the reception action suspended period out of the performance information calculation cycle on the basis of the motion cycle, for example, in such a way that positioning satellite signals corresponding to N motion cycles are received allows pieces of measurement information to be averaged. As a result, variation in the reception frequency is eliminated, and an error in performance information measurement is reduced.

### BRIEF DESCRIPTION OF THE DRAWINGS

The disclosure will be described with reference to the accompanying drawings, wherein like numbers reference like elements.

FIG. 1 shows an example of the configuration of a portable electronic apparatus.

FIG. 2 describes intermittent driving.

FIG. 3 shows an example of changes in a reception frequency in a case where no intermittent driving is performed.

FIG. 4 shows an example of changes in the reception frequency in a case where intermittent driving according to an embodiment of the disclosure is performed.

FIG. 5 shows an example of a functional configuration of a baseband processing circuit.

FIG. 6 describes a motion cycle detection method on the basis of values measured with an acceleration sensor.

FIG. 7 is a flowchart showing an example of a baseband process.

### DESCRIPTION OF EXEMPLARY EMBODIMENTS

### Overall Configuration

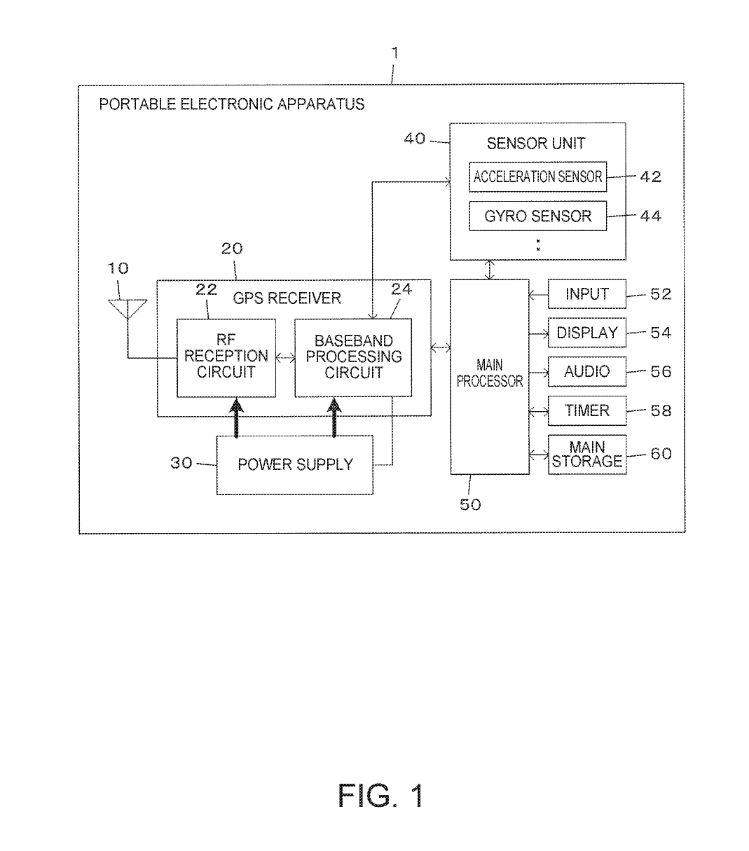

FIG. 1 shows the configuration of a portable electronic apparatus 1 in an embodiment of the disclosure. The portable electronic apparatus 1 is a compact electronic apparatus attached to or carried by a user's body for use and achieved, for example, in the form of a wristwatch-type wearable computer called a running watch. The portable electronic apparatus 1 may, of course, be attached to a body part other than an arm, such as a wrist and a forearm, for example, any of the limbs, such as an ankle. The present embodiment will be described with reference to a case where the portable electronic apparatus 1 is attached to an arm.

According to FIG. 1, the portable electronic apparatus 1 includes a GPS antenna 10, a GPS receiver 20, a power supply 30, a sensor unit 40, a main processor 50, an input 52, a display 54, a audio 56, a timer 58, and a main storage 60.

The GPS antenna 10 is an antenna that receives an RF (radio frequency) signal containing a GPS satellite signal, which is a positioning satellite signal transmitted from a GPS satellite.

The GPS receiver 20 receives the GPS satellite signal transmitted from the GPS satellite and calculates the position and velocity of the GPS receiver 20 on the basis of a navigation message, such as orbit information (ephemeris and almanac) of the GPS satellite, superimposed on and carried by the received GPS satellite signal. The GPS receiver 20 includes an RF reception circuit 22 and a baseband processing circuit 24. The RF reception circuit 22 and the baseband processing circuit can be manufactured as separate LSIs (large scale integration) or can each be manufactured as a single chip.

The RF reception circuit 22 down-converts the RF signal received with the GPS antenna 10 into an intermediate-frequency signal (IF signal), amplifies and otherwise processes the intermediate-frequency signal, then converts the processed signal into a digital signal, and outputs the digital signal. In place of the conversion to an intermediate-frequency signal, the RF reception circuit 22 may be configured as a reception circuit using a direct conversion method for directly converting an RF signal into a baseband signal.

The baseband processing circuit 24 uses data in the signal received by the RF reception circuit 22 to capture and track a GPS satellite signal and uses time information, satellite orbit information, and other types of information extracted from the captured GPS satellite signal to calculate the position of the GPS receiver 20 (portable electronic apparatus 1) and a timepiece error.

The power supply 30 supplies each portion of the GPS receiver 20 (RF reception circuit 22 and baseband processing circuit 24) with electric power in accordance with a power supply control signal from the baseband processing circuit 24.

The sensor unit 40 is a sensor unit including a variety of sensors, such as an acceleration sensor 42 and a gyro sensor 44. The sensor unit 40 can be configured, for example, by using an inertia measurement device (inertia sensor).

The main processor 50 is a processor that oversees and controls each portion of the portable electronic apparatus 1 in accordance with a variety of programs, such as a system program, stored in the main storage 60, and the main processor 50 includes a CPU (central processing unit) or any other processor. The main processor 50 uses the position calculated by the baseband processing circuit 24 and values measured with the sensors provided in the sensor unit 40 to calculate performance information, such as the position, the velocity, the cumulative travel distance, the heart rate, the number of steps, running pitch, and the pace of the user to whom the portable electronic apparatus 1 is attached.

The input 52 is an input device formed, for example, of a touch panel and button switches and outputs an operation signal according to the user's operation to the main processor 50. The display 54 is a display device formed, for example, of an LCD and performs a variety of types of display on the basis of a display signal from the main processor 50. The audio 56 is a sound output device formed, for example, of a loudspeaker and performs a variety of types of sound output on the basis of a sound signal from the main processor 50. The timer 58 is an internal timepiece, is formed of an oscillation circuit having a quartz oscillator and other components, and measures the current time, an elapsed period from specified timing, and other parameters.

The main storage 60 is a storage device formed, for example, of a ROM (read only memory) and a RAM (random access memory) and not only stores the system program that allows the main processor 50 to oversee and control each portion of the portable electronic apparatus 1, programs, data, and other types of information for achieving a variety of functions of the portable electronic apparatus 1 but also is used as a work area for the main processor 50 and temporarily stores results of computation performed by the main processor 50, operation data from the input 52, and other types of information.

### Principle

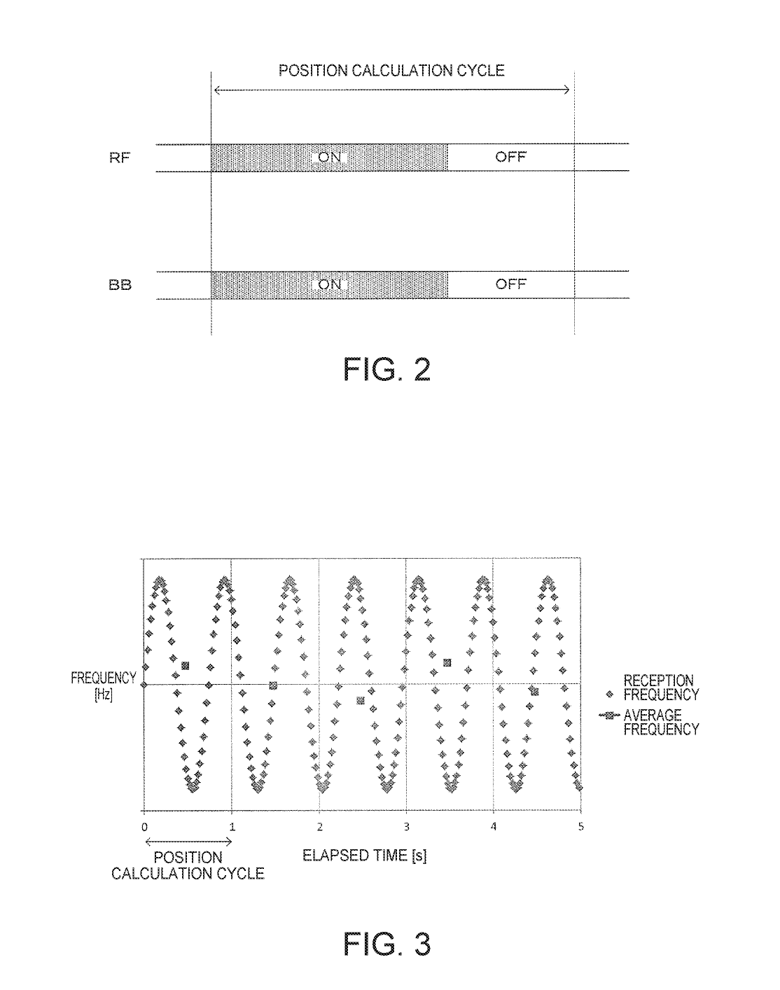

The GPS receiver 20 intermittently drives the RF reception circuit 22 and the baseband processing circuit 24 to achieve power saving. FIG. 2 shows an outline of intermittent driving in the GPS receiver 20. In FIG. 2, the upper portion shows the state of action of the RF reception circuit 22 (labeled with “RF”), and the lower portion shows the state of action of the baseband processing circuit 24 (labeled with “BB”).

To allow the RF reception circuit 22 and the baseband processing circuit 24 to synchronize with each other, what is called duty control in which action in an ON-state period (ON period) and action in an OFF-state period (OFF period) are repeated with the ON period and the OFF period forming a position calculation cycle (1 second, for example) as a unit period is performed, as shown in FIG. 2. The OFF period is a reception action suspended period for which no GPS satellite signal is received.

The ON state of the RF reception circuit 22 is a state of action in which the power supply 30 supplies the RF reception circuit 22 with electric power and the RF reception circuit 22 performs the following circuit action (reception action): amplification of the RF signal received with the GPS antenna 10; down-conversion into an intermediate-frequency signal (IF signal); removal of unnecessary frequency components; and conversion of the received signal, which is an analog signal, into a digital signal. The OFF state of the RF reception circuit 22 is a state in which the power supply 30 supplies the RF reception circuit 22 with no electric power and the RF reception circuit 22 does not perform the circuit action described above. The OFF state may instead be a state in which electric power is supplied to part of the RF reception circuit 22 but no electric power is supplied to the remainder of the RF reception circuit 22.

The ON state of the baseband processing circuit 24 is a state of action in which the power supply 30 supplies the baseband processing circuit 24 with electric power and the baseband processing circuit 24 can carry out the GPS satellite capturing process and the position calculation process and perform the intermittent action control. The OFF state of the baseband processing circuit 24 is a state of action in which the power supply 30 supplies the baseband processing circuit 24 with electric power but the baseband processing circuit 24 does not carry out the capturing process or the position calculation process described above (suspend action) but performs the intermittent action control, and it can also be said that the OFF state is what is called a sleep state. In the OFF state, the clock of action may be lowered as compared with that in the ON state.

The ratio of the ON period to the unit period is called a duty ratio. For example, when the duty ratio is 40%, 0.4 seconds out of the position calculation period, which is 1 second, is the ON period, and the remainder of the position calculation period or 0.6 seconds is the OFF period.

The duty ratio in the intermittent driving is determined in accordance with the cycle of motion of the user to whom the GPS receiver 20 (portable electronic apparatus 1) is attached. Walking, running, or any other similar motion is accompanied by a cyclic body motion, such as forward and rearward alternate movement of both arms. When the user runs with the GPS receiver 20 (portable electronic apparatus 1) attached to the user's arm, the cycle of the forward and rearward arm swinging action (arm swinging cycle) corresponds to the user's motion cycle. The duty ratio in the intermittent driving is so set that the period equal to N times the user's arm swinging cycle (N is a natural number) out of the position calculation cycle is the ON period and the remainder of the position calculation cycle is the OFF period. In the present embodiment, it is assumed that N=1, that is, the period equal to the arm swinging cycle is set as the ON period. For example, when the arm swinging cycle is 0.7 seconds, 0.7 seconds out of the position calculation cycle, which is 1 second, is the ON period, and the remainder of the position calculation cycle, which is 0.3 seconds, is the OFF period, which means that the duty ratio is 70%.

The ON period and the OFF period in the position calculation cycle are so set that the ON period precedes the OFF period, as shown in FIG. 2. That is, the OFF period corresponds to the reception action suspended period, and the ON period corresponds to the period other than the reception action suspended period.

In the GPS receiver, a GPS satellite signal reception frequency varies due, for example, to a Doppler effect that occurs when the relative positional relationship between the GPS receiver and the GPS satellite changes. When the GPS receiver is attached to an arm of a user who is walking or running, a vector representing the relative velocity between the GPS receiver and the GPS satellite cyclically varies due to the user's forward and rearward cyclic arm swinging action, and the variation causes cyclic variation in the Doppler effect. As a result, an error is superimposed on the reception frequency. To avoid the error, in the present embodiment, the duty ratio in the intermittent driving is so set that the ON period in the position calculation cycle is N times the arm swinging cycle for suppression of degradation in position calculation accuracy with power consumption reduced. The principle of the above operation will be described with reference to the drawings.

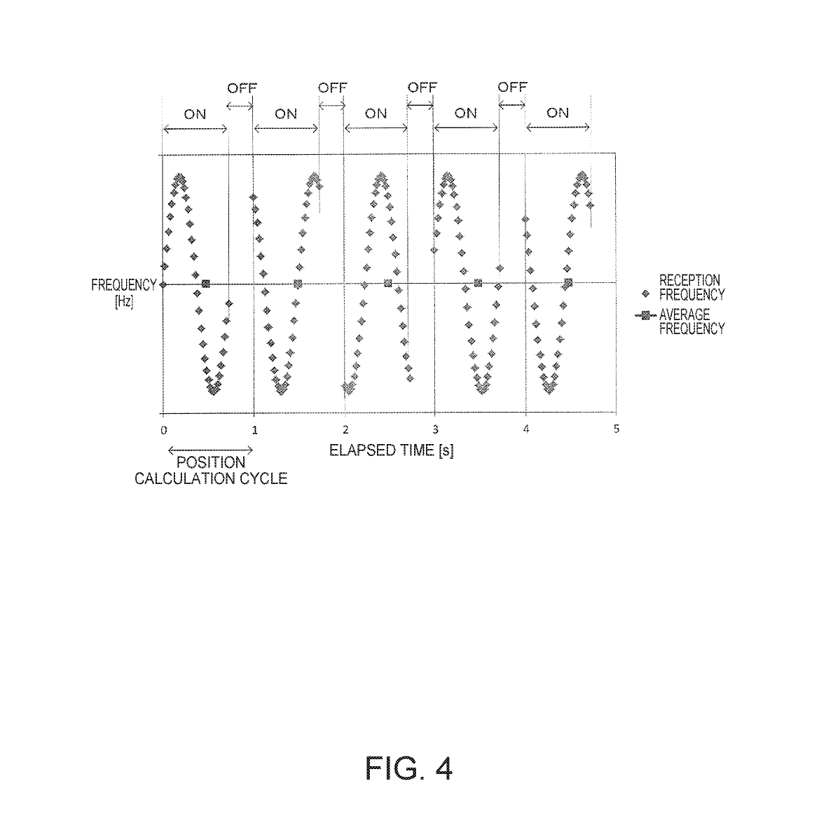

FIGS. 3 and 4 both show results of simulation computation in a case where the user runs with the GPS receiver attached to the user's arm and specifically show the GPS satellite signal reception frequency in the GPS receiver and the average of the reception frequencies in the position calculation cycle (1 second). In FIGS. 3 and 4, the horizontal axis represents time, and the vertical axis represents the frequency. It is noted that the position calculation cycle is set at 1 second and the cycle of the user's arm swinging action is set at 0.7 seconds. Further, each average frequency is plotted in rightward/leftward central position of the corresponding position calculation cycle for clarity.

FIG. 3 shows a case where no intermittent driving is performed. The reception frequency varies in the cycle of 0.7 seconds, which is the arm swinging cycle, as shown in FIG. 3. Further, the position calculation cycle (1 second) does not coincide with the cycle of the user's arm swinging action (0.7 seconds). That is, the average frequency is the average of the reception frequencies corresponding to about 1.4 (=1/0.7) times the cycle of the arm swinging action. As a result, it is found that the average frequency varies in each position calculation cycle. The position calculation computation basically uses all signals received during a position calculation cycle. More accurately, a large number of sampling points of time are present during a position calculation cycle, and the code phase, the Doppler frequency, and other measurements are calculated at each of the sampling points of time. The position calculation computation uses entire measurement information calculated during the position calculation cycle.

It can therefore be said that the average frequencies shown in FIGS. 3 and 4 serve as an index representing the entirety of all signals (entire measurement information) received during a position calculation cycle. The fact that the average frequency varies means that the entirety of measurement information (Doppler frequency, in particular) to be used in a position calculation cycle disadvantageously changes, and performing position calculation computation with no countermeasure disadvantageously degrades the position calculation accuracy.

FIG. 4 shows a case where the intermittent driving according to the present embodiment is performed. The reception frequency varies in the cycle of 0.7 seconds, which is the cycle of the arm swinging action. The intermittent driving is performed in 1 second, which is the position calculation cycle, under the conditions that the ON period is set at 0.7 seconds, which is equal to the arm swinging cycle, and the OFF period is set at 0.3 seconds, which is the remainder of the position calculation cycle. In this case, the average frequency is the average of the reception frequencies corresponding to one cycle (0.7 seconds) of the arm swinging action and hardly varies. Degradation in the position calculation accuracy is therefore avoided. In addition, since the intermittent driving is performed, power consumption can be reduced.

### Configuration of Baseband Processing Circuit

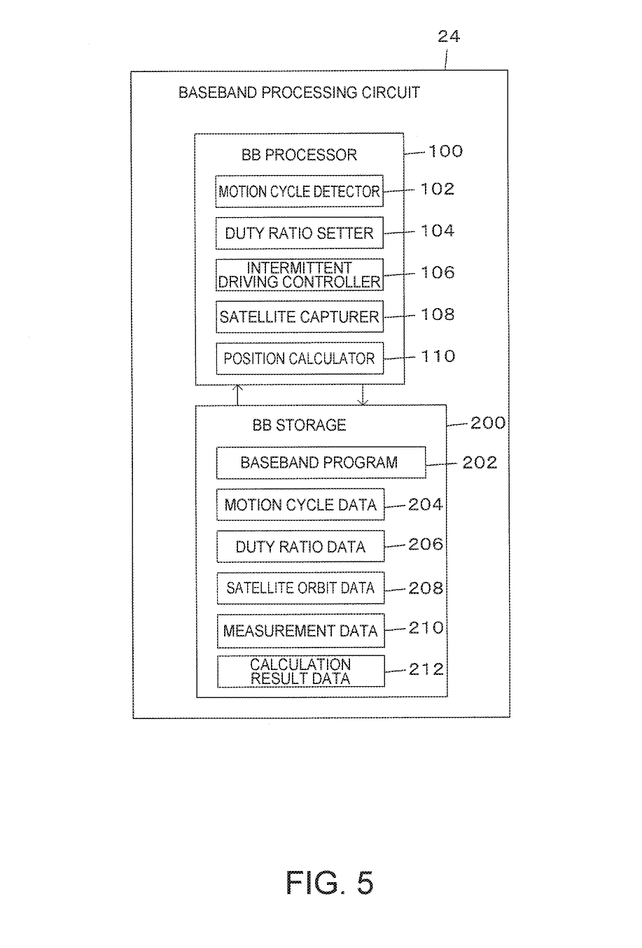

FIG. 5 is a functional configuration diagram of the baseband processing circuit 24. The baseband processing circuit 24 includes a BB processor 100 and a BB storage 200, according to FIG. 5.

The BB processor 100 is achieved by a CPU, a DSP, or any other processor and oversees and controls each portion of the baseband processing circuit 24. The BB processor 100 includes a motion cycle detector 102, a duty ratio setter 104, an intermittent driving controller 106, a satellite capturer 108, and a position calculator 110.

The motion cycle detector 102 detects the cycle of motion of the user to whom the GPS receiver 20 (portable electronic apparatus 1) is attached on the basis of results of measurement made by the sensor unit 40. For example, when the GPS receiver 20 (portable electronic apparatus 1) is attached to the user's arm for use, the motion cycle detector 102 detects the user's forward/rearward arm swinging cycle as the motion cycle. The arm swinging cycle can be detected from values measured with the acceleration sensor 42 provided in the portable electronic apparatus 1. Specifically, FFT (Fast Fourier Transform) or any other frequency analysis is performed on values measured with the acceleration sensor 42, and in a case where the user is in motion accompanied by body motion, a result of the analysis can be used to detect the frequency of the body motion.

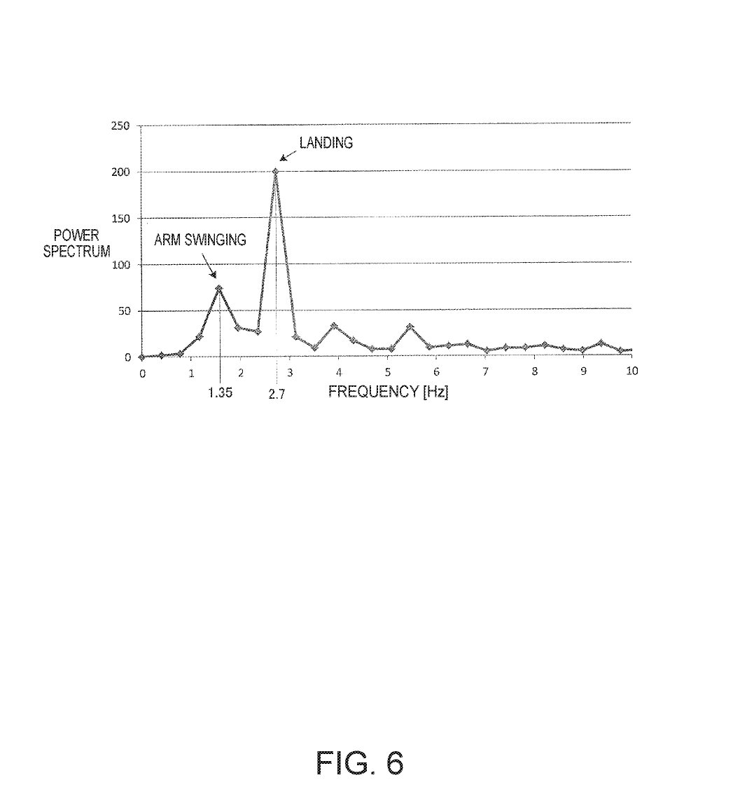

FIG. 6 shows an example of a result of the frequency analysis performed on values measured with the acceleration sensor 42. FIG. 6 shows a result of the frequency analysis (result of FFT operation) performed on values measured with the acceleration sensor in a case where a user whose arm wears the acceleration sensor is running. A frequency spectrum, which is the result of the frequency analysis, has two peaks, as shown in FIG. 6. The peaks correspond to the cycle of changes in the acceleration detected with the acceleration sensor 42 at the time of running. Specifically, the peaks are classified into a peak resulting from the swinging action of the arm to which the acceleration sensor 42 (portable electronic apparatus 1) is attached and a peak resulting from landing. Since the right and left legs land on the ground during a single cycle of the arm swinging action, the arm swinging frequency is half of the landing frequency. It is therefore found that the peak at a lower frequency is the peak corresponding to the arm swinging action, and that the peak at the higher frequency is the peak corresponding to the landing. Since the GPS receiver 20 in the present embodiment is a receiver that is attached to an arm, the motion cycle detector 102 can select two peak frequencies of a power spectrum that have a relationship in which one of the frequencies is twice the other frequency and detect the lower frequency as the arm swinging frequency. The arm swinging cycle (motion cycle) can be determined from the arm swinging frequency. The motion frequency detected by the motion cycle detector 102 is stored as motion cycle data 204.

The duty ratio setter 104 sets the duty ratio in the intermittent driving on the basis of the motion cycle detected by the motion cycle detector 102. Specifically, the duty ratio is set by setting the motion cycle to be the length of the ON period and setting the remaining length of the position calculation cycle excluding the motion cycle to be the length of the OFF period. The duty ratio set by the duty ratio setter 104 is stored as duty ratio data 206.

The intermittent driving controller 106 controls the baseband processing circuit 24 and the RF reception circuit in such a way that they are intermittently driven in accordance with the duty ratio set by the duty ratio setter 104. Specifically, the intermittent driving controller 106 starts the ON period at position calculation timing that occurs in each position calculation cycle (1 second) and starts the OFF period at the time when the ON period ends. The intermittent driving controller 106 repeats the starting operation as described above to control the power supplied by the power supply 30 in accordance with a power supply control signal in such a way that each of the baseband processing circuit 24 and the RF reception circuit 22 repeats the ON state and the OFF state at the set duty ratio.

The satellite capturer 108 performs digital signal processing, such as carrier (carrier wave) removal and correlation operation, on data (received data) in a signal received by the RF reception circuit 22 to capture a GPS satellite (GPS satellite signal).

The position calculator 110 acquires satellite orbit data 208 and measurement data (measurement information) 210 on each GPS satellite captured by the satellite capturer 108 and carries out a position calculation process using the acquired data in each predetermined position calculation cycle (1 second, for example) to calculate the position of the GPS receiver 20, a timepiece error (clock bias), and the speed of movement. A least-square method, a Kalman filter, or any other known method is applicable to the position calculation process. In this process, when the intermittent driving controller 106 is performing the intermittent driving control, data acquired during the ON period in a position calculation cycle is used to carry out the position calculation process.

The satellite orbit data 208 are data, for example, on the almanac and ephemeris of each GPS satellite and acquired by decoding a received GPS satellite signal. To only capture a GPS satellite, almanac data suffices, but to calculate the position of the GPS receiver 20 (portable electronic apparatus 1), ephemeris data is required. The measurement data 210 are data, for example, on the code phase and the Doppler frequency relating to a received GPS satellite signal and acquired on the basis of a result of correlation operation performed between the received GPS satellite signal and a replica code. Data on the position and timepiece error calculated by the position calculator 110 are accumulated and stored as calculation result data 212.

The BB storage 200 is achieved by a ROM, a RAM, and other storage devices and not only stores the system program that allows the BB processor 100 to oversee and control the baseband processing circuit 24, programs, data, and other types of information for achieving a variety of functions but also is used as a work area for the BB processor 100 and temporarily stores results of computation performed by the BB processor 100 and other types of information. In the present embodiment, the BB storage 200 stores a baseband program 202, the motion cycle data 204, the duty ratio data 206, the satellite orbit data 208, the measurement data 210, and the calculation result data 212.

### Process Procedure

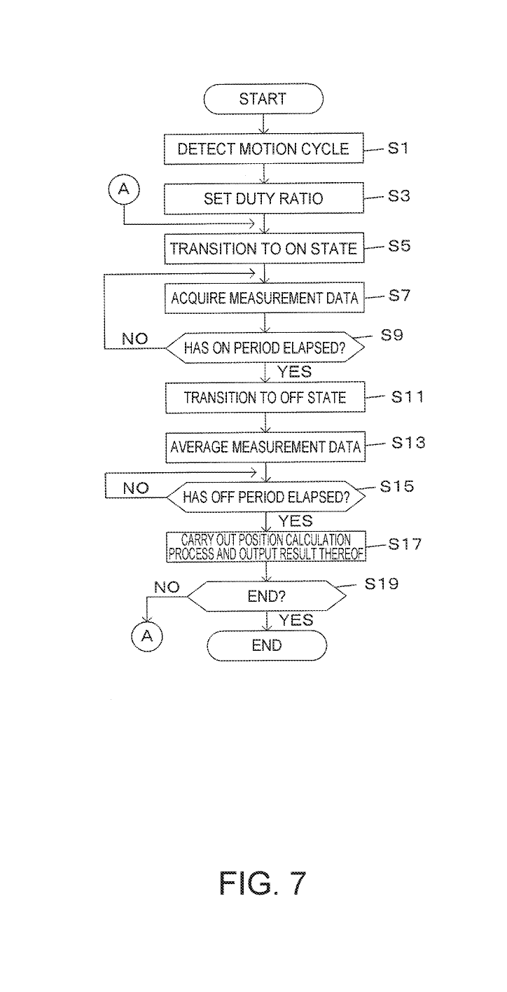

FIG. 7 is a flowchart for describing the procedure of a baseband process. The baseband process is achieved when the BB processor 100 executes the baseband program 202.

The motion cycle detector 102 first detects the cycle of motion of the user to whom the GPS receiver 20 (portable electronic apparatus 1) is attached (step S1). The duty ratio setter 104 then sets the duty ratio in the intermittent driving on the basis of the detected motion cycle (step S3).

The intermittent driving controller 106 then starts the intermittent driving control according to the set duty ratio. That is, the intermittent driving controller 106 causes the GPS receiver 20 (baseband processing circuit 24 and RF reception circuit 22) to transition to the ON state (step S5). The RF reception circuit 22 then performs reception action to receive a GPS satellite signal, and the baseband processing circuit 24 acquires the measurement data 210 from the GPS satellite signal (step S7).

When the ON period specified by the duty ratio has not elapsed (step S9: NO), the control returns to step S7. When the ON period has elapsed (step S9: YES), the intermittent driving controller 106 causes the GPS receiver 20 (baseband processing circuit 24 and RF reception circuit 22) to transition to the OFF state (step S11). The acquired measurement data are subsequently averaged (step S13). The code phases and the Doppler frequencies are averaged. When the OFF period specified by the duty ratio has elapsed (step S15: YES), the position calculator 110 carries out the position calculation process using the averaged measurement data and stores and outputs a result of the calculation (step S17).

The BB processor 100 then evaluates whether or not the baseband process is terminated in accordance with whether or not a termination instruction has been externally inputted. When a result of the evaluation shows that the baseband process is not terminated (step S19: NO), the control returns to step S5 and the same processes are repeated. When a result of the evaluation shows that the baseband process is terminated (step S19: YES), the baseband process is terminated.

### Advantageous Effects

As described above, the portable electronic apparatus 1 according to the present embodiment intermittently drives the RF reception circuit 22 and the baseband processing circuit 24 in such a way that they repeat the ON period, for which a GPS satellite signal is received, and the OFF period, for which no GPS satellite signal is received, with the position calculation cycle based on the GPS satellite signal serving as the unit period. In this case, the length of the ON period is set to be equal to the cycle of the arm swinging action of the user to whom the portable electronic apparatus 1 is attached, and the length of the OFF period is set at the remaining length of the position calculation cycle excluding the cycle of the arm swinging action (that is, the length of the ON period). As a result, variation in measurements (Doppler frequency, in particular) received during a position calculation cycle can be suppressed with the power consumption reduced by the intermittent driving of the GPS receiver 20, whereby degradation in the position calculation accuracy can be suppressed.

### Variations

An embodiment to which the present disclosure is applicable is, of course, not limited to the embodiment described above, and the embodiment described above can be changed as appropriate to the extent that the change does not depart from the substance of the present disclosure.

### (A) Motion Cycle and Duty Ratio

In the embodiment described above, one motion cycle out of the position calculation cycle is set as the ON period, but a plurality of motion cycles may be set as the ON period. Specifically, N motion cycles (N is a natural number) can be set as the ON period, and the remainder of the position calculation cycle excluding the N cycles can be set as the OFF period. For example, when the position calculation cycle is 1 second and the motion cycle is 0.4 seconds, 0.8 seconds corresponding to two motion cycles can be set as the ON period, and the remaining 0.2 seconds can be set as the OFF period.

### (B) Further Intermittent Driving in ON Period (Fine Intermittent Driving)

In the ON period out of the position calculation cycle, the intermittent driving may be performed in a finer manner. For example, the intermittent driving may be performed every 20 ms, which is the CA code cycle, or every 1 ms. Power consumption can therefore be further reduced.

### (C) Motion Accompanied by Body Motion

The above embodiment has been described with reference to the case where running or walking is considered as the motion accompanied by the user's cyclic body motion, and the motion accompanied by the user's cyclic body motion may, of course, be other types of motion, for example, bicycle riding.

### (D) Satellite Positioning System

The description has been made with reference to GPS as a satellite positioning system, and any other satellite positioning system, such as WAAS (Wide Area Augmentation System), QZSS (Quasi Zenith Satellite System), GLONASS (GLObal NAvigation Satellite System), GALILEO, and BeiDou (BeiDou Navigation Satellite System), may be used.

What is claimed is:

1. A performance information calculation method executed by an apparatus carried by a user who makes motion accompanied by cyclic body motion, the method comprising:
detecting motion cycle of the user;
setting a reception action suspended period, during which a positioning satellite signal is not received, in each predetermined calculation cycle on the basis of the motion cycle; and
calculating performance information in each of the calculation cycles on the basis of the positioning satellite signal received in a period other than the reception action suspended period.

2. The performance information calculation method according to claim 1,
wherein the setting includes setting a remainder of the calculation cycle excluding N times the motion cycle (N is a natural number) to be the reception action suspended period.

3. The performance information calculation method according to claim 2,
wherein the N equals to 1.

4. The performance information calculation method according to claim 1, further comprising
intermittently performing reception of the positioning satellite signal in a period of the calculation cycle excluding the reception action suspended period.

5. The performance information calculation method according to claim 1,
wherein the calculating the performance information includes
averaging measurement information of the positioning satellite signal received during the calculation cycle, and
calculating the performance information using the averaged measurement information.

6. A positioning satellite signal receiver carried by a user who makes motion accompanied by cyclic body motion, the receiver comprising:
a processor configured to;
detect motion cycle of the user;
set a reception action suspended period, during which a positioning satellite signal is not received, in each predetermined calculation cycle on the basis of the motion cycle; and
calculate performance information in each of the calculation cycles on the basis of the positioning satellite signal received in a period other than the reception action suspended period.
